(19) United States
(12) Patent Application Publication
(10) Pub. No.: US 2020/0134520 A1
(43) Pub. Date: Apr. 30, 2020

(54) METHOD AND SYSTEM FOR DYNAMICALLY IMPROVING THE PERFORMANCE OF SECURITY SCREENING

(71) Applicant: Rutgers, The State University of New Jersey, New Brunswick, NJ (US)

(72) Inventors: Paul B. Kantor, Madison, WI (US); Dennis E. Egan, Westfield, NJ (US); Vladimir Menkov, Bloomington, IN (US)

(21) Appl. No.: 16/494,138

(22) PCT Filed: Mar. 14, 2018
(86) PCT No.: PCT/US18/22477

§ 371 Date: Sep. 13, 2019

Related U.S. Application Data
(60) Provisional application No. 62/470,976, filed on Mar. 14, 2017.

(51) Int. Cl. G06Q 10/06; G06Q 50/26; G07C 9/00; G01N 23/04; G01V 5/00

(52) U.S. Cl. CPC G06Q 10/0635; G06Q 50/26; G07C 2011/04; G01N 23/04; G01V 5/0008; G07C 9/00309

(57) ABSTRACT

A system for security screening at a venue includes one or more security screening stations, each station having a security level and configured to screen a plurality of subjects in a queue for admitting the subject to the venue. The system may determine the current queue length of all the queues associated with security screening stations based on data received from one or more sensors. The system may also determine whether the throughput for at least one security screening station should be increased or decreased. If the system so determines, the system may decrease or increase, for a variation time period, the security level of the security screening station associated with the queue. The system may also adjust configuration of the stations or place a secondary and complementary screening process to dynamically improve the performance of the security system.

### CROSS-REFERENCE TO RELATED APPLICATIONS

This application claims priority under 35 U.S.C. § 119(e) to U.S. Provisional Patent Application No. 62/470,976, filed Mar. 14, 2017. The foregoing applications are incorporated by reference herein.

### GOVERNMENT FUNDING

This application was made at least with partial Government support under contracts 2009-ST-061-CCI002-05 suppl, all of which were awarded by the Department of Homeland Security.

### BACKGROUND

This disclosure relates to a security system and particularly to dynamically improve the performance of a security system at a venue or a location.

Security measures allow the public to continue to live normal lives in an increasingly dangerous world. Because of the increasing dangers, security precautions are becoming common aspects of modern life. For example, security checkpoints at airports and other public locations provide increased safety to the public through the screening, location, and collection of harmful items, thereby helping to prevent the presence of these harmful items in the public locations.

However, such security checkpoints may cause delays and congestion at a location or venue due to long queues. This can adversely impact customer services at such location, as well as pose security risks. Even if advances in security system technologies may someday obviate having to queue up single file, congestion and corresponding delays will still be likely. To reduce congestion, an operator may sometimes adjust the level of sensitivity and/or the detection threshold of one or more security systems at a checkpoint to reduce the processing time. However, this may also compromise the security level of such security systems. For example, an unauthorized person may adjust the sensitivity or the detection threshold of a security system to circumvent security and/or may wait to go through a security checkpoint when congestion is high and the sensitivity level of a security system is likely to be low. It is therefore desirable to develop a security system for which the processing time can be dynamically and automatically adjusted based on real-time data relating to congestion to increase the throughput of the system while maintaining the security of the system. It is also desirable that unauthorized persons should not be able to predict and/or exploit information relating to when and where the detection thresholds of a security system might change temporarily.

This document describes devices and methods that are intended to address at least some of the issues discussed above and other issues.

### SUMMARY

Systems and methods for dynamically improving the performance of a security screening system are disclosed. In an embodiment, the system for security screening, may include one or more security screening stations installable at a venue. Each security screening station may have an adjustable security level and may be configured to screen a plurality of subjects in a queue associated with the security screening station. The system may also include one or more sensors configured to gather data corresponding to queue lengths of one or more queues associated with the one or more security screening stations, a processor, and a non-transitory computer-readable storage medium containing programming instructions. The system may be configured to receive data corresponding to the queue lengths of one or more queues associated with the one or more security screening stations, determine a current queue length of all the queues associated with the one or more security screening stations, determine whether a throughput for at least one security station of the one or more security screening stations should be increased or decreased, and change, for a variation period, a security level of the at least one security screening station upon determining that the throughput for the at least one security station should be increased or decreased from an original value to an adjusted value. Upon expiration of the variation period, the system may return the security level to the original value, and repeat the steps of receiving, determining the current queue length, determining whether the throughput for at least one security station of the one or more security screening stations should be increased or decreased, and changing.

Optionally, the security level of the security screening station may be a sensitivity level associated with a detector of the security screening station.

In an embodiment, the system may determine whether the throughput for at least one security station of the one or more security screening stations should be increased or decreased based on one or more of the following: a maximum security wait time for the venue, a combined size of all of the queues associated with all the security screening stations, a desired overall level of detection, and/or the security level of all other queues associated with all of the one or more security screening stations. Optionally, adjusting the security level of the security screening station may be configured to decrease or increase the original value of security level by an amount so that an overall average security is maintained at an acceptable level. Optionally, the overall average security may be the overall level of detection.

In an embodiment, determining whether the throughput for at least one security station of the one or more security screening stations should be increased or decreased may include making the determination based on information about national security, statistics about security settings of the system in past events similar to a current event, and/or subject-specific information related to one or more patrons waiting in the queue associated with the one or more security screening stations. Subject-specific information related to one or more patrons may include an identification of a person, a license plate number of a vehicle, and/or information about past violation by a person.

In an embodiment, the variation period may be a random time period corresponding to a time less than the current estimated wait time of the at least one security screening station.

In certain embodiments, the system may also be configured to upon determining that the throughput for at least one security station of the one or more security screening stations should be decreased or increased, adjust a configuration of the one or more security screening stations at the venue. Adjusting the configuration of security screening stations may include determining that a security screening station should be closed, and transmitting a signal to the security screening station that should be closed, wherein the signal, when received by the security screen station, causes the security screening station to close. Optionally, adjusting the configuration of security screening stations may include determining that a security screening station should be closed and transmitting a signal to a signage indicating that an operator closes the security screening station. Additionally, and/or alternatively, adjusting the configuration of security screening stations may include determining that a new security screening station should be opened and transmitting a signal to the new security screening station, wherein the signal, when received by the security screening station, will cause the security screening station to open. Optionally, the system may transmit a signal to a signage indicating that an operator opens the security screening station.

In another embodiment, a security screening station having an adjustable security level and configured to screen a plurality of subjects in a queue associated with the security screening station is disclosed. The security station may include one or more sensors configured to measure a queue length of a queue associated with the security screening station, a processor, and a non-transitory computer-readable storage medium containing programming instructions. The security screening station may be configured to determine whether a throughput for the security screening station should be increased or decreased based on a reading from the one or more sensors, and adjust, for a variation period, the security level of the security screening station upon determining that the throughput for the security screening station should be increased or decreased from an original value to an adjusted value. Upon expiration of the variation period, the security screening system may return the security level to the original value, and repeat the steps of determining and adjusting.

### BRIEF DESCRIPTION OF THE DRAWINGS

FIG. 1 depicts a diagram of an example system for dynamically and automatically adjusting the performance of a security system according to an embodiment.

FIG. 2 depicts flowchart illustrating an example process for dynamically and automatically adjusting the performance of a security system illustrated in FIG. 1 according to some embodiments.

FIG. 3 depicts a diagram showing a target zone with regard to detection (of threats) and congestion (of the queues) according to some embodiments.

FIG. 4 depicts various embodiments of one or more electronic devices for implementing the various methods and processes described herein.

### DETAILED DESCRIPTION

This disclosure is not limited to the particular systems, methodologies or protocols described, as these may vary. The terminology used in this description is for the purpose of describing the particular versions or embodiments only and is not intended to limit the scope.

As used in this document, any word in singular form, along with the singular forms “a,” “an” and “the,” include the plural reference unless the context clearly dictates otherwise. Unless defined otherwise, all technical and scientific terms used herein have the same meanings as commonly understood by one of ordinary skill in the art. All publications mentioned in this document are incorporated by reference. Nothing in this document is to be construed as an admission that the embodiments described in this document are not entitled to antedate such disclosure by virtue of prior invention. As used herein, the term “comprising” means “including, but not limited to.”

The terms “memory,” “computer-readable medium” and “data store” each refer to a non-transitory device on which computer-readable data, programming instructions or both are stored. Unless the context specifically states that a single device is required or that multiple devices are required, the terms “memory,” “computer-readable medium” and “data store” include both the singular and plural embodiments, as well as portions of such devices such as memory sectors.

Each of the terms “camera,” “video capture module,” “imaging device,” “image sensing device” or “imaging sensor” refers to a software application and/or the image sensing hardware of an electronic device that is capable of optically viewing a scene and converting an interpretation of that scene into electronic signals so that the interpretation is saved to a digital video file comprising a series of images.

The term “security screening station” refers to a system or device installable at an entrance or other places of a venue and usable for screening subjects for potential security threats such as guns, explosives, flammable substances, or the like (for example, before admittance or entrance into the venue). Examples of security screening stations may include, without limitation, a walk-through detector (e.g., walk-through metal detector), a drive-through detector (e.g., drive-through metal detector), a full-body scan system, explosive trace detectors, an x-ray system, a hand-held detector (e.g., hand held metal detector), baggage screening stations, weighing stations, or the like commonly used at both public and private venues, such as airports, railway stations, buildings, sports and entertainment venues, border controls, border customs, weight stations, toll-booths, or other places. Two detectors may be “complementary” if they are effective in detecting different classes of threats, such as, for example, metal threats or bulky non-metallic objects.

The term “security system” refers to a system configured to implement a collection of security measures or protocols at a venue in order to monitor subjects for detecting security threats. Such security systems may include, without limitation, one or more security screening stations and devices that may be configured to detect security threats. The system may also be associated with bomb-sensing canines, inspectors trained in pat-down procedures, or other processes configured to detect security threats, and may cause the implementation of such processes by, for example, providing an instruction to an inspector to perform a pat-down procedure. A security system may also include signage, public address announcements, or other means for directing subjects to an appropriate security station or other security protocols.

A “processor” or “processing device” is a hardware component of a device that is configured to execute programming instructions. The term “processor” may refer to either a single processor or to multiple processors that together implement various steps of a process. Unless the context specifically states that a single processor is required or that multiple processors are required, the term “processor” includes both the singular and plural embodiments.

The term “subject” may include, without limitation, human subjects, vehicles, goods, containers, baggage, and merchants that are subject to security screening.

The term “congestion” may refer to a status of a queue or an aggregate status of multiple queues when a parameter (e.g., number of subjects, estimated wait time, etc.) of the queue(s) exceeds a desired threshold. For example, a queue(s) may be congested if the number of subjects in a queue, the longest wait time experienced, or anything that may indicate negative experience of the patrons exceeds a desired threshold. The congestion may be represented by the status of one single queue or multiple queues corresponding to multiple security stations. In case of multiple queues, the congestion may also determined based on the average or maximum of above measures across a collection of queues, or throughout the duration of an event. For example, the congestion of multiple queues may be determined based on the size of the largest queue among the multiple queues, the total size or sum of multiple queues or the largest size of multiple queues over time.

The term “throughput” refers to the number of subjects (e.g., person) that are scanned, screened, or monitored by a security screening station in a threshold time. A value of throughput may be used as a measure of the efficiency of a given security screening station and/or used as a measure of the capacity of a given security screening station.

The term “venue” is defined as any place that can be visited by one or more patrons. Examples may include, without limitation, airports, railway stations, buildings, sports and entertainment arenas, schools, shopping malls, border controls, border customs, weight stations, toll-booths, or other places.

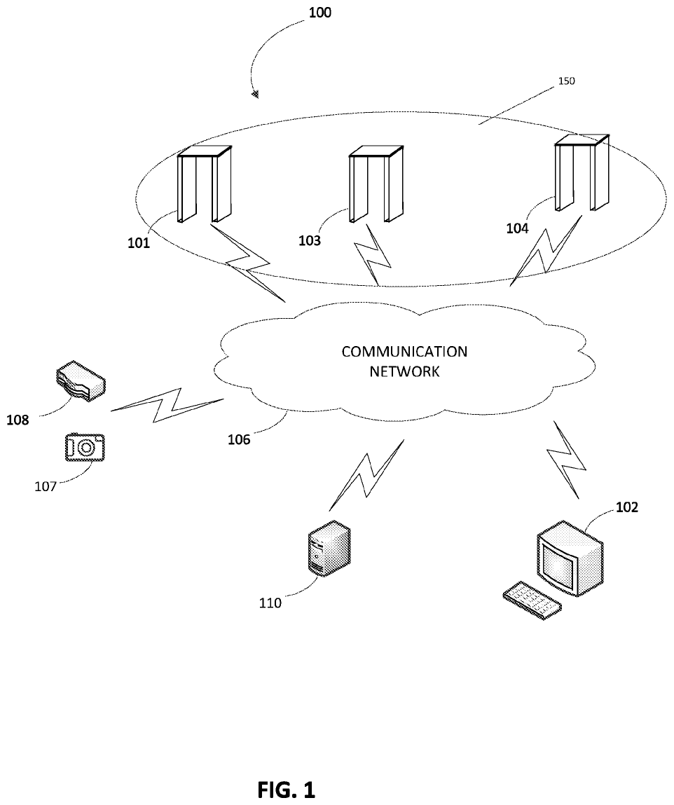

As shown in FIG. 1, a system 100 for improving the performance of security system and/or security screening station. In an emboidment, the system may include a security system 150, one or more cameras 107, one or more sensors 108, a processing device 102, and a data store 110. One or more componenets of the system 100 communicate with each other via a communication network 106.

In an emboidment, the security system 150 may include one or more security screening stations 101, 103, 104 that are installable at a venue. In an emboidment, each security screening station may be configured to screen each subject in a queue associated with the security screening station. The security screeing stations may each have an adjustable security level characterized by the corresponding sensitivity of a detector. For example, a high-security level may require a high sensitivity, and a low-security level may require a low sensitivity. In an example embodiment, where the security system 150 is installed at an airport venue for screening passengers, example security screening stations may include walk-through metal detectors, hand-held metal detectors, x-ray screening devices, or the like. In an embodiment, a walk-through metal detector may include single- or multi-zone metal detectors with digital signal processing (DSP) technologies for achieving high accuracy and performance. In a non-limiting example, the walk-through metal detector may have 4 or 8 overlapping parallel detection zones.

In some embodiments, each of the security screening stations may be configured to have a desired security level. The security level of a security screening station refers to the size, composition, class, etc. of threats (e.g., metal objects) that can be detected by the securing screening station. For example, the desired security level may be adjusted based on an estimated risk or threat level corresponding to a security system, security screening station, venue, or the like. Such a security level may be estimated based on venue characteristics, information about national security, real-time information corresponding to the venue, information obtained from a government agency, historical data corresponding to the venue, or historical data or characteristics corresponding to patrons and/or events of a given class (e.g., classical concerts; rock concerts; soccer games, etc.), or some other source. For example, a walk-through metal detector at an airport may include an automatic security level selection feature, for example, to enable a gun-reveal feature based on gun-reveal technology (GRT). Alternatively and/or additionally, security levels may be adjusted based on subject-specific information about the next subject to be screened at the security screening station. By way of example and without limitation, this may be information about a person, based on an imperfect estimation of identity using facial recognition software, or it may be information from an automatic license plate reader that the next vehicle to be processed has an out-of-state license plate. All such embodiments may use any available local or other sources of subject-specific information.

In certain embodiments, the security screeing stations (e.g., walk-through metal detector) may be configured to adjust the sensitivity for detection of threats in accordance with the security level of the security screening station. The term “sensitivity” refers to the probability that a member of some specified class of threats (e.g., threats relating to knives, guns, explosives, metals or non-metal objects, etc.) will be detected (that is, will cause the security device to flag an alarm or warning). This probability will vary with the security level “setting” of the security screening station. The sensitivity may be a single numerical value or a vector of numerical values, each value describing the probability of detection for threats belonging to each of several different classes.

In one or more embodiments, the security screening staitons may also include alert devices (e.g., audio-visual or vibrating alarm indicators), one or more communication ports for exporting statistics, an electronic hardware key switch, and/or a backup battery. In the illustrated security system, various methods may be implemented to dynamically improve the performance of the system.

The system 100 may also include one or more sensors, such as cameras 107 or other sensors 108. In an embodiment, the system 100 may use data from the one or more sensors to measure, without limitation, queue lengths and/or the estimated wait times of a queue or queues associated with a screening station. Additional examples of sensors 108 may include, but are not limited to, motion sensors embodying various technologies, passive infrared sensors, microwave/radar sensors, ultrasonic wave sensors, tomographic motion detectors, radio interference detector (RID) sensors, WiFi monitoring sensors, thermal sensors, or the like. The sensors 100 may include wired or wireless sensors.

The system 100 may also include a data store 110. In an embodiment, the data store 110 may store data and information relating to, for example, the statistical relationship between the security level, the sensitivity, and the expected subject screening rate, for each of the screening stations; historical data relating to each of the security screening stations, congestions, queue lengths, estimated wait times, or the like. The system 100 may also include a processing device 102 that may have a processor and memory containing programming instructions that, when executed, will cause the processor to perform certain functions.

Various components of the system 100 may be communicatively connected, such as via a communication network 106, via any suitable connections, wired or wirelessly and in any suitable communication protocols (e.g., the Transmission Control Protocol/Internet Protocol (IP), the HyperText Transfer Protocol (HTTP)). Examples of communication networks include, without limitation, Local Area Networks (LAN), Wide Area Networks (WAN), telephone networks, the Internet, or any other wired or wireless communication networks.

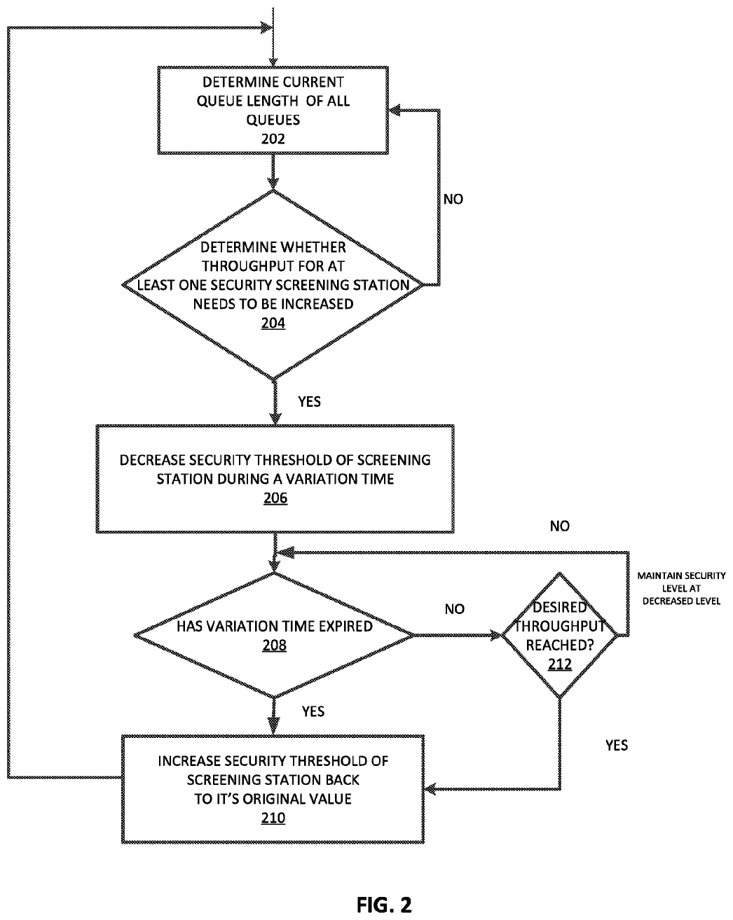

FIG. 2 illustrates an exemplary flowchart in accordance with one embodiment describing a method for improving the performance of security system and/or security screening station. While the method 200 is described for the sake of convenience and not with an intent of limiting the disclosure as comprising a series and/or a number of steps, it is to be understood that the process does not need to be performed as a series of steps and/or the steps do not need to be performed in the order shown and described with respect to FIG. 2, but the process may be integrated and/or one or more steps may be performed together, or the steps may be performed in the order disclosed or in an alternate order.

The method may begin at 202, where the system may determine and/or receive current queue length corresponding to all the queue(s) associated with security screening stations in a security system. In some embodiments, the “queue length” of a queue may be the number of subjects waiting in the queue. In some other embodiments, the “queue length” of a queue associated with a security screening station may be instantiated as the estimated wait time of the queue, i.e., the amount of time that the last person of the queue at a given moment has to wait to get to the front of the line. The system may use data received from one or more sensors to determine the number of persons and/or to estimate of the wait time of the queue. The system may estimate the wait time of the queue based on the number of subjects waiting in the queue. For example, the system may obtain historical data corresponding to the relationship between the number of subjects waiting and the actual wait time from past queues, and use those historical data to estimate the future wait time of the queue at any time based on the number of subjects in the queue. In alternate embodiments, the system may receive the queue length from the one or more sensors.

In an embodiment, the system may determine the queue length using data received from the cameras and/or other sensors of the system. For example, the system may have a camera installed near the security screening station and configured to monitor the activities in the queue associated with the station. The system may process an image stream obtained from the camera using any now or hereafter known methods to determine the number of subjects in the queue.

In some embodiments, the system may use a pressure-sensing mat to determine whether patrons are standing in locations at various distances from the security screening station so that the distance of patrons to the security stations can be determined, and may be used to determine the queue length based on the distance. In some embodiments, the system may use a wireless signal reception detector to receive radio frequency (RF) signals from one or more mobile devices that people in the line are carrying and track the multiple mobile devices to determine the number of subjects in a queue. The system may also use a machine learning algorithm or statistical algorithm to estimate the wait time of a line based on the change of position of the multiple mobile devices implied by the strength of the received RF signals from the mobile devices.

At 204, the system may determine whether the throughput for at least security screening station should be increased. In some embodiments, in determining whether the throughput for at least one security screening station should be increased, the system also ensures that increasing the throughput is possible without breaking and/or overriding the constraints of the security system (i.e., for example, the requisite security is still maintained and security is not compromised).

The system may determine whether the throughput of a security screening system should be increased by, for example, determining an estimated wait time associated with the security screening station and comparing the estimated wait time with an allowed maximum wait time for the venue. The system may determine the estimated wait time associated with the security screening station based on the estimated wait time of the queue associated with the security screening stations (or as an average of estimated wait times of multiple queues if there are multiple queues at the security screening station). If the estimated wait time exceeds the maximum wait time for the venue, the system may determine that the throughput for that security screening station should be increased. For example, at an airport where time is of the essence, a maximum security wait time may be preset to, for example, 15 minutes, 30 minutes or other values. If the system determines that the wait time for any security screening station exceeds the maximum security wait time, the system may determine that the throughput of that security screening station should be increased.

In some embodiments, the system may determine whether one or more queues corresponding to a security screening station (or even the whole security system) are congested, and upon determining that one or more queues are congested, the system may determine that the throughput of the security screening station should be increased. For example, the system may determine that a queue is congested by determining that the number of subjects in the queue has exceeded a predetermined threshold or by determining that the expected wait time of the queue has exceeded a time threshold.

Alternatively, and/or additionally, the system may also determine whether the throughput of a security screening station should be increased based on a desired overall level of detection for the security system (i.e., for all the security screening stations). For example, the system may determine and compare the average detection rate of the security system with the desired overall level of detection, and may increase the throughput of one or more security screening stations if the determined average detection rate of the security system is less than the desired overall level of detection.

In some embodiments, the average detection rate can be defined as:

d=Σ_{q}n_{q}d_{q}/Σ_{q}n_{q} (1)

where d represents the detection rate averaged over all patrons; each value of q labels a group of subjects who are screened during an event (by way of example and without limitation, the persons in a single queue who are processed during a “variation time” period for that queue). n_{q} is the number of subjects in group q, and d_{q} represents the average detection rate experienced by the subjects in group q. The summation runs over all groups of subjects who are screened during an event. Thus, the overall average detection rate is the weighted average of the corresponding detection rates for each group being screened. If the detection rate is calculated person by person, then n_{q} is always equal to 1.

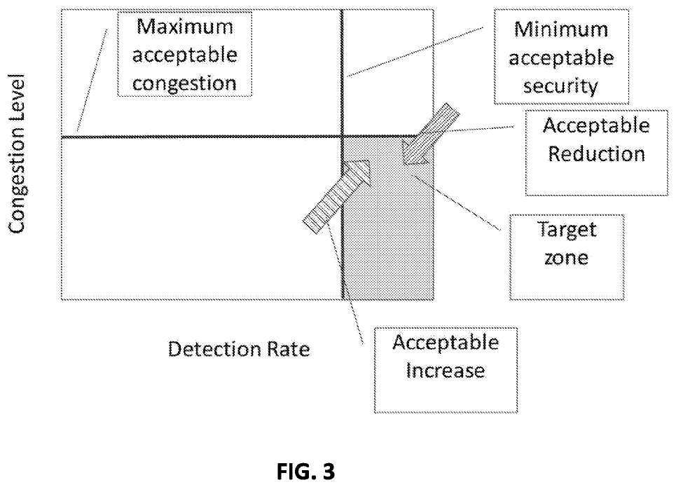

As shown in FIG. 3, a conventional target zone may be defined by congestion and detection goals or thresholds. Note that most available changes move in the two directions 301 and 302 shown in FIG. 3. For example, changes caused by an improvement in technology, such as signage to have people empty their pockets might simultaneously permit reduced congestion and increased detection rates, thus moving “down and to the right.” Various embodiments in this patent document may allow the system to move into the conventional target zone while still maintaining the desired security of the system and/or acceptable congestion. For example, in some embodiments, if the congestion is below an acceptable level, the system may determine that the detection rate should be increased. When the detection rate is above a desired threshold, the system may determine that the congestion should be decreased. In some embodiments, in determining that the congestion should be decreased, the system also determines that the congestion could be decreased while maintaining acceptable security. As shown in FIG. 3, such changes take advantage of the relation between security and congestion, when they increase or decrease together with changes in the setting of the screening device. While FIG. 3 shows only a single notional measure of both detection and congestion, in various embodiments a plurality of measures may be applied to both detection and congestion.

In some embodiments, in determining the desired overall level of detection, the system may use information such as the number of subjects in queues at venue entrances, the rate at which subjects in the queues are being scanned, screened or processed through security screening stations, the previously determined detection and false alarm rates for detecting specific kinds of weapons using various forms of security processes and technologies, and/or ticket scanning data.

In an embodiment, the system may also determine whether the throughput of a security screening station should be increased based on current status of all the queues of the security system. For example, as discussed above, the system may determine that a collection of queues are congested based on the average or maximum of above measures across a collection of queues, or throughout the duration of an event. For example, the congestion of multiple queues may be determined based on the size of the largest queue among the multiple queues, the total size or sum of multiple queues or the largest size of multiple queues over time.

If the system determines that the throughput of at least security screening station does not need to be increased, the system may continue at 202 with monitoring the current queue lengths of all security screening stations.

However, if the system determines that the throughput of at least security screening station should be increased, the system may decrease the security level of that screening station. In an embodiment, the system may decrease the security level of a security screening station by, for example, decreasing the sensitivity of a detector. For example, if the security screening station includes a metal detector, the system may decrease the sensitivity level of the metal detector. When the sensitivity level of the metal detector is decreased, more subjects may pass through the detector in a given time without triggering an alarm, and as a result, the throughput of the security screening station may be increased. In decreasing the sensitivity level of the metal detector, the system may determine the amount that the sensitivity level should be decreased, e.g., 10%, 20%, etc., such that that with the decrease of the sensitivity level the system will still maintain overall desired average security of the security system or the acceptable limit on the performance of the security system.

In some embodiments, the system may decrease the security level of the screening station only for a period of time. This period of time may be called a “variation time.” This will prevent any adversary from exploiting the system behavior by picking a security line that the adversary will know has a lower sensitivity level than that of other screening stations at the venue at the time that the adversary is screened. In some embodiments, the variation time may be randomly determined, for example, to be less than the current estimated wait time of the security screening station for which the security level is being adjusted. Other variation times are within the scope of this disclosure.

At 208, the system may determine whether the variation time has expired. If the variation time has expired, the system the system will return (210) the security level of the screening station to its original value. The system may then repeat the steps of 202, 204 and 206, such that the overall security of the system can be dynamically improved.

However, if the variation time has not expired the system may determine whether the security screening station has reached a desired throughput (212). If the system has reached a desired throughput (for example, the lengths of one or more queues of the security screening station have decreased or their corresponding wait times have decreased), than the system may increase the security level of the security screening station to the original level (and/or a different level). However, if the system has not reached a desired throughput, the system may maintain the security level at the decreased level. This process can compensate for the temporary reduction of security levels on some stations while maintaining the overall security of the venue.

In such a way, the system will dynamically improve the performance of the system while reducing the congestion of the system.

In an embodiment, the system may automatically adjust the security level of a security screening station (via, for example, a processor). Alternatively and/or additionally, the system may instruct an operator to adjust the security level of a security screening station.

In some embodiments, upon determining that the throughput of a security screening station should be increased, the system may additionally adjust the configuration of security system (i.e., all the security screening stations) at the venue. For example, the system may identify one or more screening stations to close. In such an embodiment, the system may transmit a signal to the security screening station, wherein the signal, when received by the security screen station, causes the security screening station to close. In another example, the system may display an alert message indicating that an operator opens or closes a new security screening station. In some embodiments, the system may identify a new screening station to open to ease the congestion of the other currently open screening stations and transmit a digital command to the new station to cause the new station to open. In another example, the system may transmit a signal (e.g., commands or messages) to signage that indicates a change in queuing configurations or security level change. The signage may receive the signal and display an alert to the operators or patrons of a change in screening protocols based on the received signal, e.g., a text message or an audio announcement. The alert may also alert operators or people waiting to be screened concerning their divestment of metal objects to align with the new security setting selected. In another example, the system may determine to put in place a secondary and possibly complementary screening process. In some embodiments, the system may use the security settings and secondary or complementary screening process to adjust the target levels of detection rate.

It will be understood to those skilled in the art that while the above method describes increasing the throughput of a security screening station, it may also be used to decrease the length and/or wait time of one or more queues of the security system by decreasing the security level of the security screening station corresponding to the queue, without deviating from the principles of this disclosure.

It will also be understood to those skilled in the art that while this disclosure describes increasing the throughput of a security screening station by decreasing the security level of the security screening station, similar methods can be used to decrease the throughput of a security screening station by increasing the security level without deviating from the principles of this disclosure.

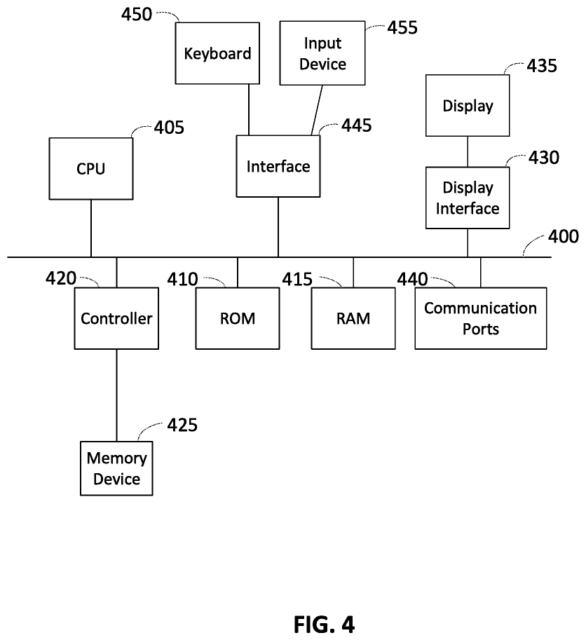

The various embodiments illustrated above will enhance the performance of the security system. FIG. 4 depicts an example of internal hardware that may be included in the security system, which may implement various methods in the embodiments described in FIGS. 1-3. An electrical bus 400 serves as an information highway interconnecting the other illustrated components of the hardware. Processor 405 is a central processing device of the system, configured to perform calculations and logic operations required to execute programming instructions. As used in this document and in the claims, the terms “processor” and “processing device” may refer to a single processor or any number of processors in a set of processors, whether a central processing unit (CPU) or a graphics processing unit (GPU) or a combination of the two. Read-only memory (ROM), random access memory (RAM), flash memory, hard drives and other devices capable of storing electronic data constitute examples of memory devices 425. A memory device also referred to as a computer-readable medium, may include a single device or a collection of devices across which data and/or instructions are stored.

An optional display interface 430 may permit information from the bus 400 to be displayed on a display device 435 in visual, graphic or alphanumeric format. An audio interface and audio output (such as a speaker) also may be provided. Communication with external devices may occur using various communication devices 440 such as a transmitter and/or receiver, antenna, an RFID tag and/or short-range or near-field communication circuitry. A communication device 440 may be attached to a communications network, such as the Internet, a local area network or a cellular telephone data network.

The hardware may also include a user interface sensor 445 that allows for receipt of data from input devices 450 such as a keyboard, a mouse, a joystick, a touchscreen, a remote control, a pointing device, a video input device and/or an audio input device. Digital image frames also may be received from an imaging capturing device 455 such as a video camera installed at the venue where the security system is installed. Other sensors may also be installed at the venue and communicatively accessible by the processor 405 via the communication device 440. In other embodiments, the various sensors may be equipped with a communication interface and software such that the readings of the sensors can be remotely accessible by a processor. For example, the camera may have a built-in HTTP server that allows access by a remote device.

Optionally, the hardware may not need to include a memory, but instead, the programming instructions are running on one or more virtual machines or one or more containers on a cloud. For example, the various steps in dynamically improving the performance of the security system as described in FIG. 2 may be implemented by a server on a cloud that includes multiple virtual machines, each virtual machine having an OS, a virtual disk, virtual network and applications or programs, and the programming instructions for implementing various functions in the robotic system may be stored on one or more of those virtual machines on the cloud.

The above-disclosed systems and methods can be used in conjunction with existing security screening systems or deployed stand-alone to provide the advantageous and benefits described above. The systems and methods embodying above illustrated embodiments can be deployed in various environments where security is required, such as large venues, e.g., airports, stadiums and concert halls, shopping malls, and other enclosed or enclosable places, private or public, etc. An organization could ensure that large numbers of persons entering its venues have been screened to current acceptable standards, while minimizing inconvenience to those persons, controlling the size of the crowd of persons not already screened, and doing so in a way that makes it very difficult for an adversary to exploit variations in the thoroughness of screening processes. The illustrated system will provide an enhanced level of safety and security to persons using or gathering in venues and to persons or organizations planning for cost-effective acquisition of security devices.

The illustrated security system may also be useful in environments such as maintaining the security of a “smart city,” in which there is a multiplicity of sensors or observation devices that may alert human agents to the increased possibility of undesirable activity. In such environments, security responses to such undesirable activities may include refocusing of cameras, dispatch of trained law enforcement officers or similar costly activities; the congestion is the mismatch between the number of alerts and the available resources; and the process or algorithms may be embodied, by way of example and without limitation, to randomly select which alerts are to be responded to, making use of available information such as the abilities of the resources to relocate or respond, or any contextual information that may indicate an increased prior probability of undesirable activity.

In some embodiments, the illustrated systems and methods may be adapted to the maintenance of the security of a computer network, or “internet of things.” For example, the system may further include a multiplicity of filters, sensors or detectors that signal the possibility of a network intrusion, such as by way of example and without limitation malware, Trojans, or known or unknown (e.g., zero-day attack) threats. The system may additionally and/or optionally, include adjustment of firewalls, or shut-down of portions of the network, or dispatch of human investigators to assess the situation. The system may include using any devices or any methods for tracking and monitoring the disposition of response resources, and their constraints or limitations. Alternatively, and/or additionally, the system randomly select which alerts are to be responded to, make use of available information such as the effectiveness of specific techniques, the mobility and capabilities of the human agents, or any contextual information that may indicate an increased prior probability of undesirable activity in the portion of the network that has generated a particular alert.

Applications utilizing the illustrated system may also include maintaining a safe and steady flow of automobile traffic through a congested area; the techniques include narrowcast of specific alternate routes to selected vehicles; the sensors include participating drivers who use a smart phone application such as Wayze to transmit information about location and velocity; the algorithms may compute a rapid reassignment of individual automobiles to a plurality of routes, using information that may include the driving behavior of specific vehicles, available information about vehicle destination, or information about the existing and projected traffic on alternative routes, to decrease the probability that any alternate route becomes overly congested during the event.

Various illustrated embodiments can also be implemented in a single security screening station. In some embodiments, a security screening station may have an adjustable security level and can be configured to screen a subject in a queue associated with the security screening station. The security screening station may include one or more sensors configured to measure a queue length of a queue associated with the security screening station, a processor, and non-transitory computer-readable storage medium. The storage medium may contain programming instructions that can cause the processor to determine whether a throughput for the queue associated with the security screening station should be increased or decreased based on a reading from the one or more sensors. The security screening station may also adjust, for a variation period, the security level of the station upon determining that the throughput for the security screening station should be increased or decreased. When the variation period expires, the station may repeat the steps of determining and adjusting. The station may set variation period a random value that is shorter than a waiting period that corresponds to the queue length of the queue associated with the station.

In some embodiments, in adjusting the security level, the security screening station may increase or decrease the sensitivity level of a metal detector of the security screening station. Alternatively, and/or additionally, the security screening station may also include a communication interface configured to receive a queue length of a queue associated with an additional security screening station. The security screening station may also adjust the security level based on the queue length associated with the additional security screening station.

The above-disclosed features and functions, as well as alternatives, may be combined into many other different systems or applications. Various presently unforeseen or unanticipated alternatives, modifications, variations or improvements may be made by those skilled in the art, each of which is also intended to be encompassed by the disclosed embodiments.

1. A system for security screening, comprising:
one or more security screening stations installable at a venue, each security screening station having an adjustable security level and configured to screen a plurality of subjects in a queue associated with the security screening station;
one or more sensors configured to gather data corresponding to queue lengths of one or more queues associated with the one or more security screening stations;
a processor;
a non-transitory computer-readable storage medium containing programming instructions that, when executed, will cause the processor to:
receive data corresponding to the queue lengths of one or more queues associated with the one or more security screening stations;
determine a current queue length of all the queues associated with the one or more security screening stations,
determine whether a throughput for at least one security station of the one or more security screening stations should be increased or decreased,
change, for a variation period, a security level of the at least one security screening station upon determining that the throughput for the at least one security station should be increased or decreased from an original value to an adjusted value, and
when the variation period expires:
return the security level to the original value, and
repeat the steps of receiving, determining the current queue length, determining whether the throughput for at least one security station of the one or more security screening stations should be increased or decreased, and changing.

2. The system of claim 1, wherein the security level of the security screening station is a sensitivity level associated with a detector of the security screening station.

3. The system of claim 1, wherein programming instructions for determining whether the throughput for at least one security station of the one or more security screening stations should be increased or decreased are configured to make the determination based on one or more of:
a maximum security wait time for the venue;
a combined size of all of the queues associated with all the security screening stations;
a desired overall level of detection; and
the security level of all other queues associated with all of the one or more security screening stations.

4. The system of claim 3, wherein programming instructions for adjusting the security level of the security screening station are configured to decrease or increase the original value of security level by an amount so that an overall average security is maintained at an acceptable level.

5. The system of claim 4, wherein the overall average security is the overall level of detection.

6. The system of claim 1, wherein programming instructions for determining whether the throughput for at least one security station of the one or more security screening stations should be increased or decreased are configured to make the determination based on one or more of:
information about national security;
statistics about security settings of the system in past events similar to a current event; and
subject-specific information related to one or more patrons waiting in the queue associated with the one or more security screening stations.

7. The system of claim 6, wherein subject-specific information related to one or more patrons comprises an identification of a person, a license plate number of a vehicle, or information about past violation by a person.

8. The system of claim 1, wherein the variation period is a random time period corresponding to a time less than the current estimated wait time of the at least one security screening station.

9. The system of claim 1, wherein programming instructions comprise additional programming instructions that, when executed, will cause the processor to:
upon determining that the throughput for at least one security station of the one or more security screening stations should be decreased or increased, adjust a configuration of the one or more security screening stations at the venue.

10. The system of claim 9, wherein programming instructions for adjusting the configuration of security screening stations comprise:
determining that a security screening station should be closed; and
transmitting a signal to the security screening station that should be closed, wherein the signal, when received by the security screen station, causes the security screening station to close.

11. The system of claim 9, wherein programming instructions for adjusting the configuration of security screening stations comprise:
determining that a security screening station should be closed; and
transmitting a signal to a signage indicating that an operator closes the security screening station.

12. The system of claim 9, wherein programming instructions for adjusting the configuration of security screening stations comprise:
determining that a new security screening station should be opened; and
transmitting a signal to the new security screening station, wherein the signal, when received by the security screening station, will cause the security screening station to open.

13. The system of claim 9, wherein programming instructions for adjusting the configuration of security screening stations comprise:
determining that a new security screening station should be opened; and
transmitting a signal to a signage indicating that an operator opens the security screening station.

14. A security screening station having an adjustable security level and configured to screen a plurality of subjects in a queue associated with the security screening station, the security station comprising:
one or more sensors configured to measure a queue length of a queue associated with the security screening station;
a processor;
a non-transitory computer-readable storage medium containing programming instructions that, when executed, will cause the processor to:
determine whether a throughput for the security screening station should be increased or decreased based on a reading from the one or more sensors,
adjust, for a variation period, the security level of the security screening station upon determining that the throughput for the security screening station should be increased or decreased from an original value to an adjusted value, and
when the variation period expires:
return the security level to the original value, and
repeat the steps of determining and adjusting.

15. The security screening station of claim 14, wherein programming instructions for adjusting the security level of the security screening station comprise programming instructions configured to cause a sensitivity level of a detector of the security screening station to increase or decrease.

16. The security screening station of claim 14, wherein the variation period is shorter than a waiting period that corresponds to a queue length of a queue associated with the security screening station.

17. The security screening station of claim 14, further comprising a communication interface, configured to receive a queue length of a queue associated with an additional security screening station, wherein programming instructions for adjusting the security level of the security screening station comprise additional programming instructions configured to adjust the security level of the second security screening station also based on the queue length associated with the additional security screening station.

18. A method for security screening, comprising, by a processor:
receiving, from one or more sensors, data corresponding to queue lengths of one or more queues associated with one or more security screening stations at a venue, wherein each security screening station has an adjustable security level and is configured to screen a plurality of subjects in a queue associated with the security screening station;
determining a current queue length of all the queues associated with the one or more security screening stations;
determining whether a throughput for at least one security station of the one or more security screening stations should be increased or decreased;
changing, for a variation period, a security level of the at least one security screening station upon determining that the throughput for the at least one security station should be increased or decreased, from an original value to an adjusted value; and
when the variation period expires:
returning the security level to the original value, and
repeating the steps of receiving, determining the current queue length, determining whether the throughput for at least one security station of the one or more security screening stations should be increased or decreased, and changing.

19. The method of claim 17, wherein the security level of the security screening station is a sensitivity level associated with a detector of the security screening station.

20. The method of claim 17, wherein determining whether the throughput for at least one security station of the one or more security screening stations should be increased or decreased comprises making the determination based on one or more of:
a maximum security wait time for the venue;
a combined size of all of the queues associated with all the security screening stations;
a desired overall level of detection; and
the security level of all other queues associated with all of the one or more security screening stations.

21. The method of claim 17, wherein the variation period is a random time period corresponding to a time less than the current estimated wait time of the at least one security screening station.
